(19) United States
(12) Patent Application Publication
(10) Pub. No.: US 2009/0115902 A1
(43) Pub. Date: May 7, 2009

(54) DISPLAY APPARATUS WITH COUNTERPROGRAM CHECKING FUNCTION

(75) Inventors: Yoshio Fukushima, Yokohama (JP); Minoru Kaneko, Yokohama (JP); Tomochika Yamashita, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 12/249,093

(22) Filed: Oct. 10, 2008

(30) Foreign Application Priority Data
Nov. 7, 2007 (JP) 2007-289157

(51) Int. Cl. H04N 5/45

(52) U.S. Cl. 348/565; 348/E05.112

(57) ABSTRACT

A display apparatus makes it possible to check video contents of another video source while continuing to watch a presently watched program. A first region for displaying first video contents, and a second region for displaying selection icons to select second video contents different from the first video contents are formed on a display screen. The selection icons make possible selection from a plurality of video sources providing the video contents and including one or more broadcasting networks and a video recording medium. The broadcasting networks are one or all of ground-based broadcasting, BS broadcasting and CS broadcasting. The video recording medium is an HDD incorporated in the display apparatus and/or a removable HDD which can be inserted into and removed from the display apparatus.

### INCORPORATION BY REFERENCE

The present application claims priority from Japanese application JP2007-289157 filed on Nov. 7, 2007, the content of which is hereby incorporated by reference into this application.

### BACKGROUND OF THE INVENTION

The present invention relates to a display apparatus such as, for example, a television apparatus for receiving a television broadcast (mainly a digital broadcast) broadcasted via a satellite, a cable, or a ground wave and displaying its video.

A conventional broadcast receiving apparatus is known by means of, for example, U.S. Pat. No. 6,166,778, Yamamoto et al. In other words, a broadcast receiving apparatus including superposed display means for conducting superimposed display of a list of counterprograms while a user is watching a program, means for displaying information of a plurality of counterprograms by means of characters in the list display of the counterprograms, means for scrolling the display of the counterprograms, and means responsive to specification of one of the displayed counterprograms for erasing the display of the list of the counterprograms, selecting the channel of the specified counterprogram, and displaying the counterprogram on the screen.

### SUMMARY OF THE INVENTION

However, it is not fully considered in U.S. Pat. No. 6,166,778 to display program information concerning the selected counterprogram and display a broadcast video on a child screen concerning the counterprogram, on a counterprogram checking screen without occupying the screen of the broadcast contents which is being watched. If a video recording medium is incorporated in the display apparatus and a video is recorded on the incorporated video recording medium, or if a removable recording medium is inserted into the display apparatus and a video is recorded on the removable recording medium, it is desirable to be able to check the recorded video contents while continuing to watch a presently watched program. In U.S. Pat. No. 6,166,778, this desire is not taken into consideration.

The present invention has been made in view of the problems, and an object thereof is to provide a technique which makes it possible to ascertain video contents of other video sources while continuing watching of a presently watched program.

In a display apparatus according to the present invention for achieving the object, a first region for displaying first video contents and a second region for displaying selection icons to select second video contents different from the first video contents are formed on a display screen. The selection icons make possible selection from a plurality of video sources providing the video contents and including one or more broadcasting networks and a video recording medium.

The broadcasting networks are one or all of ground-based broadcasting, BS broadcasting, and CS broadcasting. The video recording medium is an HDD incorporated in the display device and/or a removable HDD which can be inserted into and removed from the display device.

The present invention brings about an effect that a presently broadcasted counterprogram can be ascertained simply and fast by using a counterprogram checking screen without occupying the screen of the presently watched broadcast contents.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic configuration diagram showing an embodiment of a broadcast receiving apparatus according to the present invention;

FIG. 2 is a diagram showing a case where a default state at the time of counterprogram checking start is displayed on a screen for “counterprogram checking” without occupying a screen of presently watched broadcast contents on a display screen of the broadcast receiving apparatus according to the present invention;

FIG. 3 is a diagram showing video information (TS packets) of a counterprogram displayed on a child screen according to the present invention;

FIG. 4 is a processing flow diagram showing a first embodiment concerning “counterprogram checking” in a broadcast receiving apparatus according to the present invention;

FIG. 5 is a diagram showing an example of transitions on a display screen in an embodiment according to the present invention;

FIG. 6 is a processing flow diagram showing an example concerning “counterprogram checking” in a broadcast receiving apparatus according to the present invention; and

FIG. 7 is a diagram showing an embodiment according to the present invention.

### DESCRIPTION OF THE EMBODIMENTS

Embodiments of a broadcast receiving apparatus according to the present invention will be described with reference to the drawings.

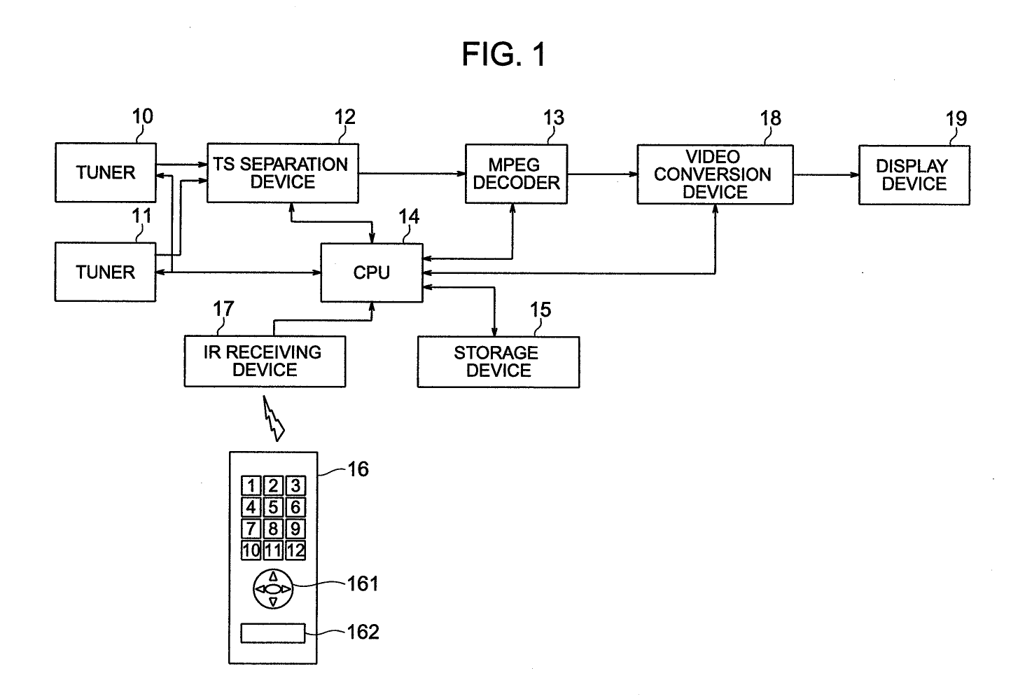

An embodiment of a broadcast receiving apparatus according to the present invention will now be described with reference to FIGS. 1 to 5. FIG. 1 is a schematic configuration diagram showing an embodiment of a broadcast receiving apparatus according to the present invention. Reference numerals 10 and 11 denote tuner parts capable of receiving a broadcast of a presently watched program and a broadcast of a counterprogram respectively at the same time. In other words, the tuner part 10 receives a broadcast of a presently watched program, and the tuner part 11 receives a broadcast of a counterprogram. For example, the tuner part 11 receives a digital broadcast signal from a digital broadcast source supplied from a broadcasting station which is not illustrated via a broadcast transmission network such as a satellite, a ground wave, or a cable, conducts station selection and detection processing at a frequency of the specified channel via a user operation part such as a remote controller serving as a user interface part and a control part (CPU) 14, then conducts digital demodulation and FEC (Forward Error Correction) processing on the signal, and outputs a digital signal (for example, MPEG2-TS) to a TS (Transport Stream) separation device 12.

The TS (Transport Stream) separation device (demultiplexer) 12 is a device for extracting (separating) a video signal (a PES (Packetized Elementary Stream) or an ES (Elementary Stream) of a video), an audio signal (a PES or an ES of an audio), and program information from broadcast signals (a plurality of transport packets of the specified channels) of the presently watched program and a selected counterprogram respectively received by the tuner parts 10 and 11. By the way, the control part (CPU) 14 stores the program information extracted by the TS separation device 12 in a storage device 15. A decoding part 13 (for example, an MPEG decoder 13) decodes the video signal (the PES or ES of the video) and the audio signal (the PES or ES of the audio) extracted by the TS separation device 12, and outputs a resultant signal. The control part (CPU) 14 has a function of controlling respective parts of the apparatus, conducting information processing, and assisting a user in selecting a program or a channel.

The storage device 15 is a device for temporarily storing information. A remote control device 16 includes a counterprogram selection button 161 which is a four-direction cursor key and a counterprogram checking button 162. BS digital broadcasting using a BS (Broadcast Satellite), ground-based digital broadcasting, or CS digital broadcasting using a CS (Communication Satellite) is selected by conducting left and right pushing operation on the counterprogram selection button 161. A channel can be selected by conducting up-down pushing operation on the counterprogram selection button 161. An IR (Infrared) receiving device (remote control receiving part) 17 receives a remote control signal, decodes the remote control signal, and transmits a resultant signal to the control part (CPU) 14. A video conversion device 18 is a device for converting a video signal of a presently watched program decoded by, for example, the MPEG decoder 13 to a broadcast video to be displayed on a presently watched screen 2, forming a counterprogram checking screen (OSD: On Screen Display) 4 on the basis of information of a counterprogram obtained from the control part (CPU) 14, and converting video information of the counterprogram decoded by, for example, the MPEG decoder 13 to a broadcast video of the counterprogram to be displayed on a child screen 3 in the counterprogram checking screen. A display device 19 is formed of a CRT, liquid crystal, or a PDP, and includes a speaker device as well.

By the way, the program information is data including contents concerning a broadcasted program and accompanying information such as broadcasting time. The broadcast information is multiplexed to the broadcast signal, received and demultiplexed, and stored in the storage device 15. However, the broadcast information may be acquired from a broadcast or communication which is different from the broadcast itself of the program and stored in the storage device 15. It is also possible to form the storage device of a HDD (Hard Disk Drive) and record a desired program on the HDD.

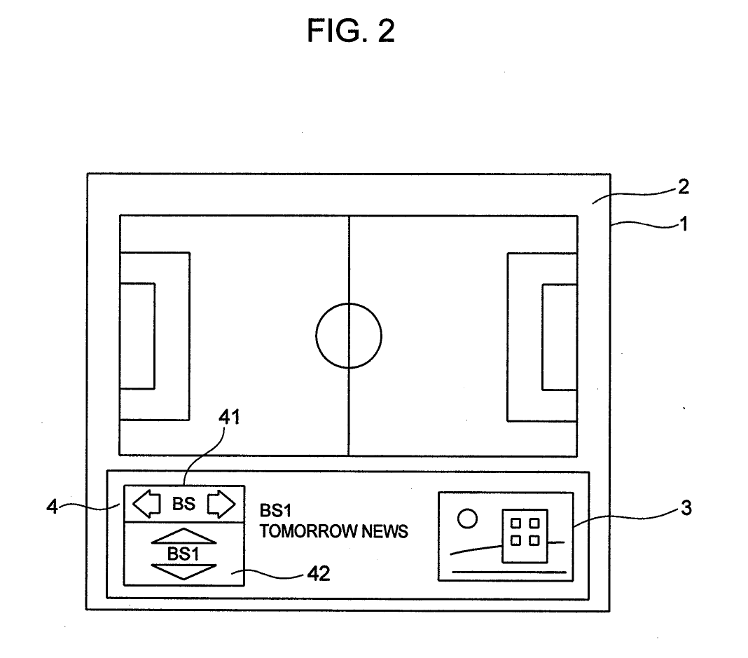

In the present embodiment, therefore, a plurality of tuners are provided. On a display screen 1 shown in FIG. 2, therefore, the control part (CPU) 14 can display second video contents, i.e., information of a counterprogram in a second region 4 located, for example, under a first region 2 for displaying first video contents, i.e., presently watched broadcast contents without occupying the first region 2. As a result, it is possible to check a counterprogram while watching the first contents. Such information of a counterprogram includes information of a counterprogram specified by button operations on the remote control device 16 and stored in the storage device 15 (character or graphic information of a network name (such as BS digital broadcasting, ground-based broadcasting, or CS digital broadcasting)/a channel number/a broadcasting station logogram/a broadcasting time zone (presently watched)/broadcast contents (only a program title)). Control is exercised so as to display a broadcast video of a counterprogram which is a video of second video contents as the child screen 3 asynchronously with a delay of at least 500 msec after the counterprogram checking information is fixed. By the way, FIG. 2 shows a state of default (display of a presently watched program) at the time of start of the “counterprogram checking” screen.

The dimension of the counterprogram checking screen 4 in the vertical direction is set equal to approximately 25% or less of the dimension of the display screen in the vertical direction in order to prevent watching of the presently watched program from being obstructed largely (i.e., from being occupied). As for information concerning broadcast contents displayed on the counterprogram checking screen 4, therefore, only a program title is displayed. As long as the dimension of the counterprogram checking screen 4 in the vertical direction satisfies the above-described. numerical value, however, a simple description text which represents contents of the program (for example, a category, performers, a summary and so on of the program) may be displayed in addition to the program title. Furthermore, in order to further improve the visibility of the presently watched program, the counterprogram checking screen 4 may be made semitransparent so as to transmit a part of the presently watched video through the counterprogram checking screen 4.

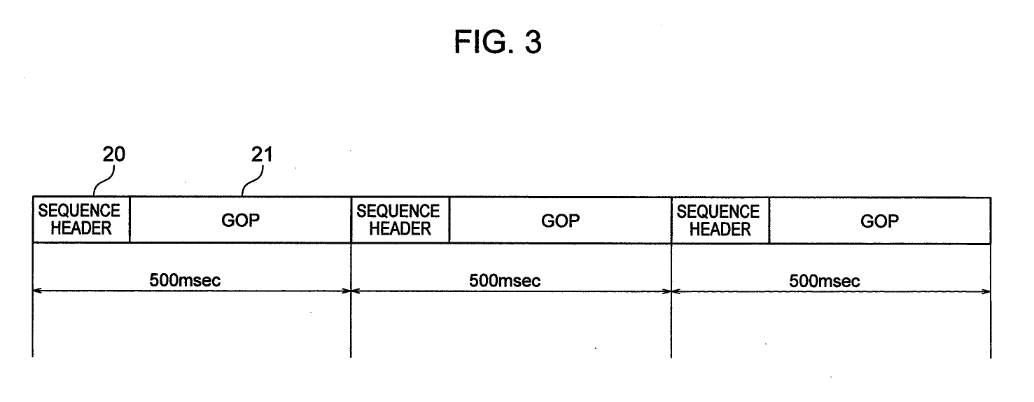

As shown in FIG. 3, video information (TS packets) displayed on the child screen 3 is formed by taking a group (500 ms) including a sequence header 20 and a GOP (Group of Picture) 21 as the unit. Therefore, it takes 500 msec at maximum to acquire video information to be displayed on the child screen 3. The GOP 21 is a video data group unit for conducting moving picture compression. One group unit of GOP is formed of pictures of as many frames (approximately 15 frames) as required to display moving pictures of 0.5 second. Each group unit includes one frame of I (Intra) picture at its head. As a result, it becomes possible to start display on the child screen from an arbitrary GOP 21 on the stream. By the way, the sequence header 20 is provided immediately before each GOP, and the reproduction start location of the recorded video data can be determined on the basis of the sequence header.

In the present embodiment, display of information of a selected counterprogram (character or graphic information concerning a counterprogram) and display of a broadcast video of the counterprogram (video information concerning the counterprogram) on the child screen are executed asynchronously, for example, on the counterprogram checking screen in the lower region without occupying the screen of the presently watched broadcast contents. As a result, the counterprogram can be ascertained simply and instantaneously.

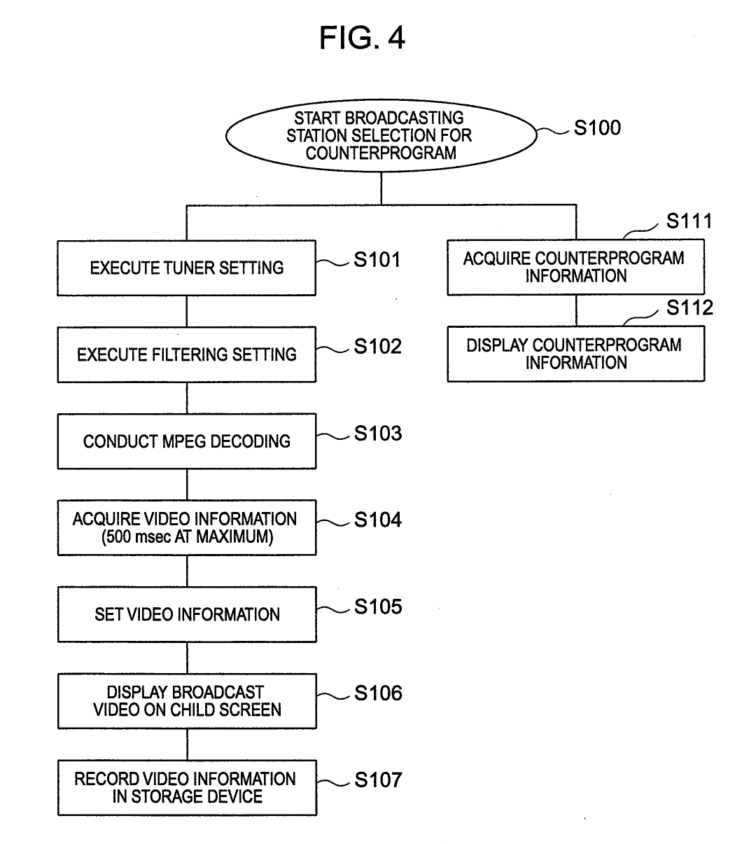

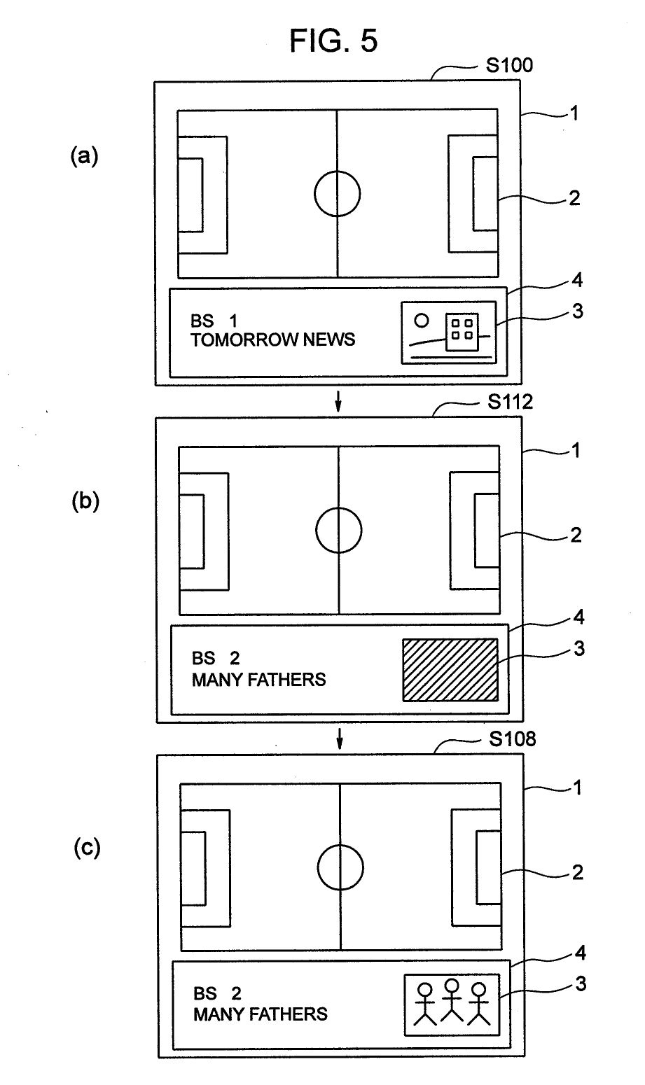

Control for instantaneously displaying counterprogram information (character or graphic information of a counterprogram) specified by button operation on the “counterprogram checking” screen, for example in the lower region and asynchronously displaying a broadcast video of the counterprogram as the child screen in the “counterprogram checking” screen without occupying the screen of presently watched broadcast contents in the broadcast receiving apparatus according to the present embodiment will now be described with reference to FIG. 4. First, the counterprogram checking button 162 on the remote control device 16 is pressed. As a result, its signal is transmitted from the remote control device 16 to the IR receiving device 17 and input to the control part (CPU) 14. Consequently, the “counterprogram checking” screen 4 is started and broadcasting station selection (specification) for a counterprogram is begun (S100). At this time, re-selection, blanking and voice muting are not conducted. As for the default at the time of the start, the presently watched program is displayed as shown in FIG. 2 and (a) of FIG. 5. If the counterprogram checking button 162 or a returning button (not illustrated) is pressed during the starting, the start is canceled.

Subsequently, the counterprogram selection button 161 is operated. As a result, its signal is transmitted from the remote control device 16 to the IR receiving device 17 and input to the control part (CPU) 14. Consequently, a counterprogram is selected (specified). The pertinent channel is selected by conducting operation of “determine” on the remote control device 16. At this time, the [counterprogram checking] screen 4 is kept at the displayed state. If the presently watched program is selected, channel re-selection is not conducted. If the start is conducted by using the counterprogram checking button 162, time out takes place three minutes after disappearance of operation.

Last selected channel information is not stored, and a presently watched program is displayed when the child screen is started. In the case where the initial scan of the ground-based digital broadcasting is not conducted, the network changeover is skipped because there is no program information. If “ch ⇑/⇓” is pressed during the start of the counterprogram checking, channel up/down of the parent screen is conducted.

A channel which is set to “do” in “menu/reception setting/ground-based digital/CH skip setting” is skipped and it cannot be selected. If AC on/off is conducted after the ground-based digital broadcasting is scanned, the title may be cleared. If a broadcasting station is determined in the counterprogram checking (the counterprogram checking button 162), then the counterprogram checking is finished.

As for start conditions of the counterprogram checking, the following is considered.

(1) The counterprogram checking display is not started during a data broadcast (during display of a message “operation cannot be done during data broadcast”), during display of “maintenance mode”, during display of “service adjustment screen”, and during display of two screens.

Except those aforementioned, the counterprogram checking is provided with posterior priority which is equivalent in start priority to the TV menu.

(2) During the counterprogram checking display, start of a data broadcast is inhibited.

(3) When “return” is pressed and when start of another user application has occurred, the counterprogram checking display is finished.

If the counterprogram checking is thus started and selection (specification) of a counterprogram is begun, then the control part (CPU) 14 reads out and acquires counterprogram information of the selected (specified) counterprogram (character or graphic information concerning the counterprogram) stored in the storage device 15 (S111). As shown in (b) of FIG. 5, the control part (CPU) 14 instantaneously displays the acquired counterprogram information on the “counterprogram checking” screen 4 in, for example, the lower region on the display screen 1 of the display device 19 via the video conversion device 18 without occupying the screen 2 of the presently watched broadcast contents (S112). It thus becomes possible to instantaneously ascertain the acquired counterprogram information.

Contents of the program information displayed on the “counterprogram checking” screen 4 in, for example, the lower region are character or graphic information of a network name/a channel number/a broadcasting station logogram/a broadcasting time zone (presently watched)/broadcast contents (only a program title).

During the “counterprogram checking” display, a broadcasting network which is one of video sources providing video contents (a broadcast source such as ground-based digital/BS/CS) is changed over by using left-right direction keys, i.e., “cursor ←/→” of the cursor key 161 on the remote control device 16, and a CH (channel) in each network is changed over by using up-down direction keys, i.e., “cursor ⇑/⇓” of the cursor key 161. Program information corresponding to the CH is displayed.

As shown in FIG. 2, the network and CH changeover is conducted with reference to selection icons including a network changeover key 41 which is a first selection icon and a channel changeover key 42 which is a second selection icon displayed on the counterprogram checking screen 4. The broadcasting network changeover key 41 is an icon for changing over the broadcasting network such as the digital ground-based broadcasting and the BS broadcasting. The broadcasting network changeover key 41 changes over the broadcasting network in cooperation with operation of the left-right direction key, i.e., “cursor ←/→”. For example, each time “cursor →” is pressed, the broadcasting network is changed over in a predetermined order. FIG. 2 shows an example in which BS is selected as the network.

The channel changeover key 42 is an icon for changing over the CH broadcasted in the network which is selected by the network changeover key 41 as the second video contents. The channel changeover key 42 changes over the CH in cooperation with operation on the up-down direction keys, i.e., “cursor ⇑/⇓”. For example, each time “cursor ⇑” is pressed, the CH is changed over in order from a small-numbered channel to a large-numbered channel. FIG. 2 shows an example in which the first BS channel is selected as the channel of BS broadcasting. Selection of a counterprogram is facilitated by the configuration heretofore described.

In (a) to (c) of FIG. 5, illustration of the network changeover key 41 and the channel changeover key 42 is omitted to simplify the description.

As for the changeover order of the “network name”, the presently watched network is set as the default as described below.

“BS [symbol] ” “Ground-based digital” [symbol] “CS”

[symbol]

As for the order of “CH number”, the presently watched “CH” is set as the default in the same way as the “program table”.

When the program in the counterprogram checking is in the following state, the default is set as follows:

(1) During watching an external input . . . last digital channel

(2) HDD reproduction . . . last digital channel

(3) During watching ground-based analog . . . last ground-based digital channel

(4) When started for the first time in the state of (1), (2) or (3) after shipping setting . . . BS 101 ch

If the counterprogram checking is started and selection (specification) of a counterprogram is begun, then the control part (CPU) 14 executes steps S101 to S106 asynchronously with the program information acquisition step S111 and the program information display step S112. It thus becomes possible to display a broadcast video of a selected counterprogram on the child screen 3 in the “counterprogram checking” screen 4 as shown in (c) of FIG. 5. In other words, the child screen (moving picture) 3 is displayed after the counterprogram selection is begun and the counterprogram checking information is fixed. For thus displaying the broadcast video of the counterprogram on the child screen while displaying the broadcast contents of the presently watched program on the screen 2, it is necessary to provide at least two tuners 10 and 11 as shown in FIG. 1. In the ensuing description, it is supposed that the broadcast contents concerning the presently watched program are received by, for example, the tuner 10 and the broadcast contents concerning the counterprogram are received by, for example, the tuner 11.

Display of the broadcast contents of the presently watched program on the screen 2 will now be described in brief. A broadcasting station of a program to be watched is selected by operating, for example, keys on the remote control device 16. Under the control of the control part (CPU) 14, tuner setting is executed on the tuner part 10 which receives a digital broadcast signal, and a broadcasting station selection and detection processing are conducted at a frequency of the specified program to be watched. Thereafter, a resultant signal is subjected to digital demodulation and error correction processing. A resultant digital signal (for example, MPEG2-TS) is output. Subsequently, under the control of the control part (CPU) 14, TS filtering setting is executed on the TS (Transport Stream) separation device 12 with respect to the selected (specified) program to be watched. As a result, a video signal of the program to be watched (a PES or an ES of the video) is extracted from a plurality of transport packets of the program to be watched which are output from the tuner part 10. Subsequently, the decoding part (including the MPEG decoder) 13 decodes the video signal of the program to be watched which is obtained from the TS separation device 12. As a result, it becomes possible to acquire video information of the program to be watched. Subsequently, the control part (CPU) 14 sets video information for the program to be watched on the video conversion device 18. As a result, it becomes possible for the display device 19 to display a broadcast video of the program to be watched on the presently watched screen 2 as shown in FIG. 2.

Subsequently, selection of a broadcasting station of a counterprogram is begun, and the counterprogram is selected (specified). Under the control of the control part (CPU) 14, tuner setting is executed on the tuner part 11 which receives a digital broadcast signal, and a broadcasting station selection and detection processing are conducted at a frequency of the specified counterprogram. Thereafter, a resultant signal is subjected to digital demodulation and error correction processing. A resultant digital signal (for example, MPEG2-TS) is output (S101). Subsequently, under the control of the control part (CPU) 14, TS filtering setting is executed on the TS (Transport Stream) separation device 12 with respect to the selected (specified) counterprogram. As a result, a video signal of the counterprogram (a PES or an ES of the video) is extracted from a plurality of transport packets of the counterprogram which are output from the tuner part 11 (S102). Subsequently, the decoding part (for example, the MPEG decoder) 13 decodes the video signal of the counterprogram obtained from the TS separation device 12 (S103). As a result, it becomes possible to acquire video information of the counterprogram in 500 msec at maximum (S104). Subsequently, the control part (CPU) 14 sets video information for the counterprogram on the video conversion device 18 (S105). As a result, it becomes possible for the display device 19 to display a broadcast video of the counterprogram on the child screen 3 in the “counterprogram checking” screen as shown in (c) of FIG. 5 at least 500 msec later (S106).

Video information (the sequence header 20) of the counterprogram displayed on the child screen 3 is also recorded in the storage device 15 (S107). If a “determine” button disposed in, for example, the center of the counterprogram selection button 162 is pressed with respect to the counterprogram displayed on the child screen 3, then the counterprogram is displayed on the main screen 2 for displaying the presently watched program, by using the sequence header 20 recorded in the storage device 15. Concurrently with this, the counterprogram checking screen 4 is erased. If the video information (the sequence header 20) of the counterprogram displayed on the child screen 3 is thus recorded in the storage device 15, then the counterprogram can be displayed on the main screen 2 promptly when the counterprogram is selected as the program to be displayed on the main screen 2.

While the video of the counterprogram is being displayed on the child screen 3, video information is changed due to commercials, program changeover or the like sometimes. Whenever video information in the sequence header is changed, therefore, the sequence header is re-recorded to update the recorded contents. As a result, the latest video information is always provided by the child screen 3.

It is possible to display on the child screen 3 making a distinction between aspect ratios 16:9 and 4:3 depending upon the broadcast source.

The following operations are considered as regards the child screen 3.

(1) Display on the child screen 3 is conducted approximately 2 seconds, which is at least 500 msec, after the counterprogram information changeover is finished. The reason is that it is desirable to give priority to speedy retrieval (confirmation) of the counterprogram information and it is not desirable to lower the speed because of time required to select a broadcasting station for the child screen.

(2) In (a), (b) and (c) of FIG. 5, the display area of the child screen 3 is fixed. Even when the child screen display is not conducted, characters are not disposed in the child screen display area.

(3) The display of the program information becomes later than the display on the child screen sometimes because of the relations in scan. However, it is permitted.

(4) Side panel display on the child screen is conducted in the same way as its display on the single screen.

In other words, the side panel is attached intact in display (no matter whether there is pan scan). Letter (with pan scan) is displayed in aspect ratio 16:9 with the upper and lower parts cut out.

<16:9 child screen coordinates>, <4:3 child screen coordinates>, and <OSD display region> will now be described. It follows that <16:9 child screen coordinates> (x, y, w, h)=(785, 444, 147, 86), <4:3 child screen coordinates> (x, y, w, h)=(823, 444, 109, 86), and <OSD (On Screen Display) display region> (x, y, w, h)=(0, 437, 960, 103).

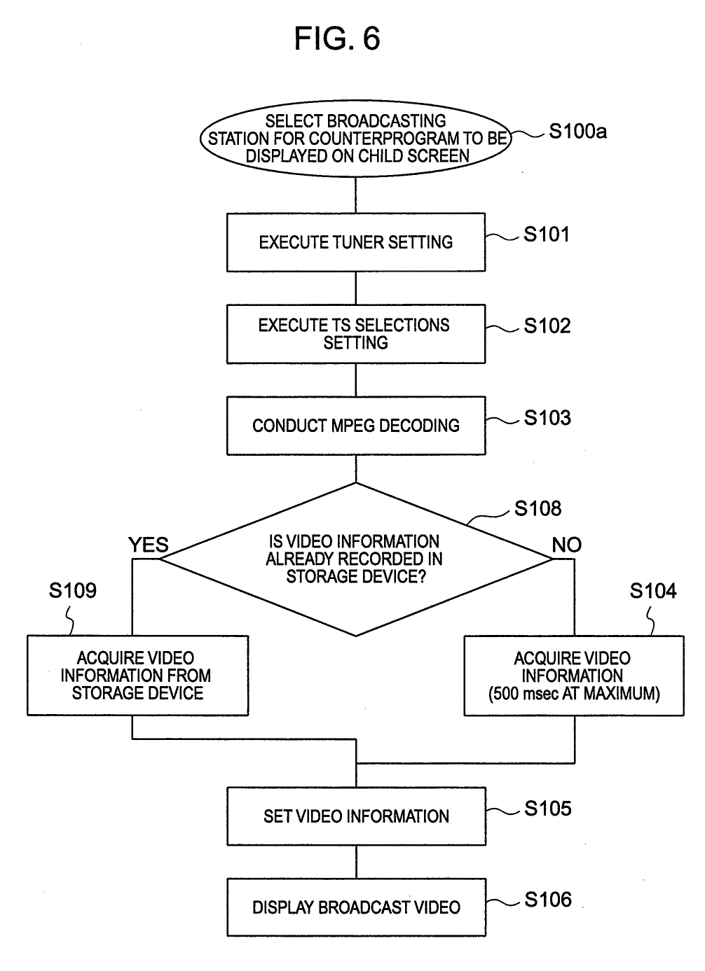

Another example of a configuration for acquiring video information of a broadcast video concerning a counterprogram will now be described with reference to FIG. 6. In other words, FIG. 6 shows a processing flow of the broadcast video of the counterprogram displayed on the child screen 3. A broadcasting station is selected for the counterprogram to be displayed on the child screen, at step S100a. Steps S101 to S103 are the same as those shown in FIG. 5. In the example, the control part (CPU) 104 determines whether video information of the pertinent counterprogram recorded at the step S107 shown in FIG. 4 is already recorded, at a stage in which the video information of the counterprogram is subjected to MPEG recording (S108). If already recorded, the control part (CPU) 104 acquires video information of the counterprogram for the child screen from a group unit (GOP 21 immediately preceded by the sequence header 20) recorded in the storage device 15 (S109). If not yet recorded, the control part (CPU) 104 acquires video information of the counterprogram for the child screen from an arbitrary group unit (GOP 21 immediately preceded by the sequence header 20) on the stream (500 msec at maximum (S104). Video information setting is conducted on the video information of the counterprogram thus acquired, at step S105. As a result, it becomes possible to display the broadcast video of the counterprogram on the child screen 3 at step S106.

According to the example, the video information of the counterprogram to be displayed on the child screen is recorded in the storage device 15 as heretofore described. If the broadcasting station of the counterprogram is selected, therefore, it becomes possible to display the broadcast video on the child screen 3 without waiting for 500 msec at maximum.

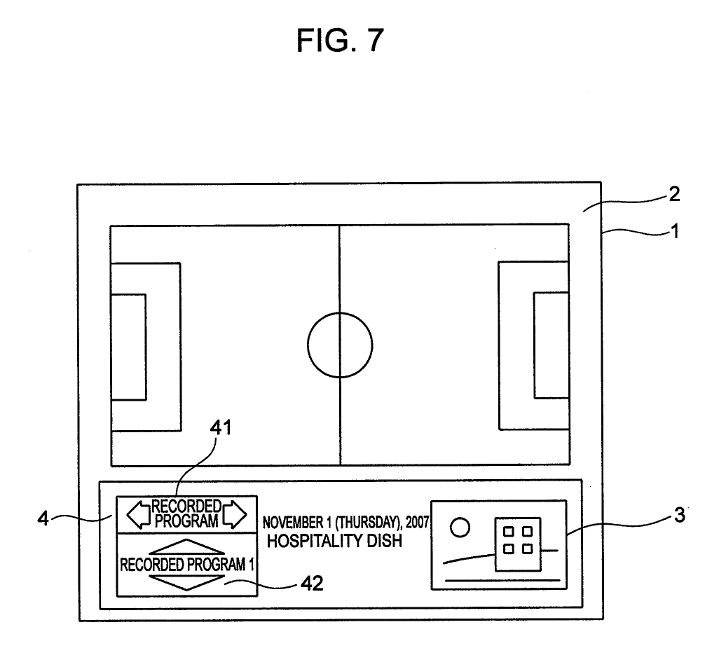

An embodiment of the display apparatus according to the present invention will now be described with reference to FIG. 7. In the foregoing embodiment, there are only broadcasting networks such as ground-based digital broadcasting, BS digital broadcasting, and CS digital broadcasting as video sources which provide video contents. In the present embodiment, however, a video recording medium can also be selected as the video source. In other words, the present embodiment makes it possible to display information of a program recorded on a recording medium, other than a broadcasting network (such as BS digital broadcasting, ground-based digital broadcasting, and CS digital broadcasting, on the second region as second video contents and check the recorded program, while displaying a program presently watched which is first contents on the first region as shown in FIG. 7.

The recording medium is, for example, the storage device 15, or a HDD (Hard Disk Drive) incorporated in the display apparatus. Although not illustrated, the recording medium may be a removable HDD which is inserted into the display apparatus so as to be able to be inserted and removed. The present embodiment is useful when recording a desired program on a video recording medium such as an HDD by using the display apparatus and checking contents of the recorded program while continuing to watch the presently watched program. In other words, the present embodiment makes it possible to check a recorded program besides a counterprogram. Details of the check will be described hereafter.

As shown in FIG. 7, the presently watched program is displayed on the screen 2 as first video contents. If the counterprogram checking button 162 on the remote control device 16 is pressed at this time, the screen which is the second region is displayed on a display part. Each time one of the left-right direction keys on the cursor key 161 provided on the remote control device 16 is pressed, the video source displayed on the network changeover key 41 is changed over successively as follows:

“BS” [symbol] “Ground-based digital” [symbol] “CS” [symbol] “Recorded program”

[symbol]

In the present embodiment, a “RECORDED PROGRAM” recorded on, for example, the HDD is added to broadcasting networks such as “BS”, “Ground-based digital” and “CS” as a choice of video sources. When a broadcasting network such as “BS”, “Ground-based digital” or “CS” is selected as the video source, the up-down direction keys on the cursor key 161 corresponding to the second selection icon operate as described above. If the up-down direction keys on the cursor key 161 are pressed when a broadcasting network is selected, a channel number is displayed on the channel changeover key 42 in the above-described example. In the present example, however, a program identifier (here “Recorded program 1” as shown in FIG. 7) given to each recorded program is displayed. The changeover display of the recorded program responsive to operation of the up-down direction keys on the cursor key 161 is conducted in, for example, the order in which it is recorded. The changeover display may be conducted in the order of name (for example, in order of the Japanese syllabary or in alphabetical order) regardless of the recording time. In what sort of order the changeover display is conducted depends upon the sort state of programs in the storage device 15. For example, if a plurality of recorded programs are sorted in the order of recording time in the storage device 15, then recorded program information is changed over and displayed in the order of recording time (or the reversed order of recording time) in response to operation of the up-down direction keys on the cursor key 161. If a plurality of recorded programs are sorted in the order of name in the storage device 15, then recorded program information is changed over and displayed in the order of name in response to operation of the up-down direction keys on the cursor key 161.

In the present embodiment, contents of the recorded program information displayed on the counterprogram checking screen 4 serving as the second region are character or graphic information such as the recording mode/recording date/recoding day of the week/broadcasting time zone/program title. In addition, a compressed video of a recorded program read out from the storage device 15 is displayed on the child screen 3. The compressed video displayed on the child screen 3 may be a moving picture or may be a thumb nail of a still picture.

Display of the first video contents and the second video contents as described above is conducted by the video conversion device 18 which is a video processing circuit. The display changeover is conducted by causing the CPU 14 to control the video conversion device 18 in response to user's operation on the remote control device 16.

According to the configuration of the present embodiment, the [counterprogram checking] becomes possible not only for a presently broadcasted program but also for a recorded program, and it becomes possible to ascertain various video contents different from a desired program while watching the desired program.

It should be further understood by those skilled in the art that although the foregoing description has been made on embodiments of the invention, the invention is not limited thereto and various changes and modifications may be made without departing from the spirit of the invention and the scope of the appended claims.

1. A display apparatus capable of displaying video contents based on a broadcast signal, the display apparatus comprising:
a display part for displaying the video contents; and
a video processing part for forming a first region to display first video contents and a second region to display a selection icon used to select second video contents different from the first video contents,
wherein
the selection icon can change over and display at least one from among a plurality of video sources providing the video contents, and
the video sources include broadcasting networks and a video recording medium.

2. The display apparatus according to claim 1, wherein the broadcasting networks include any one or all of ground-based broadcasting, BS broadcasting and CS broadcasting.

3. The display apparatus according to claim 1, wherein the video recording medium is an HDD incorporated in the display apparatus.

4. The display apparatus according to claim 1, wherein the video recording medium is a removable HDD which can be inserted into and removed from the display apparatus.

5. The display apparatus according to claim 1, wherein besides the selection icon, a video of second video contents selected by the selection icon is displayed in the second region.

6. The display apparatus according to claim 5, wherein the video of the second video contents is changed over and displayed asynchronously with selection of the second video contents using the selection icon.

7. The display apparatus according to claim 1, wherein the selection icon comprises a first selection icon for changing over the video source, and a second selection icon for selecting one from among a plurality of video contents provided by the video source as the second video contents.

8. The display apparatus according to claim 6, wherein when a broadcasting network is selected as the video source by the first selection icon, the second selection icon can select one from a plurality of channels broadcasted by using the broadcasting network.

9. The display apparatus according to claim 6, wherein when a video recording medium is selected as the video source by the first selection icon, the second selection icon can select one from a plurality of video contents recorded on the video recording medium.

10. The display apparatus according to claim 6, further comprising a remote control device to operate the display apparatus,
wherein
the remote control device comprises a cursor key,
the first selection icon is for selecting the video source in response to operation on left-right direction keys on the cursor key, and
the second selection icon is for selecting the second video contents in response to operation on up-down direction keys on the cursor key.

11. The display apparatus according to claim 4, wherein in addition a video source name, a channel number, a broadcasting time zone (presently watched), and broadcast contents of the second video contents are displayed.

12. The display apparatus according to claim 10, wherein the broadcast contents are represented by a program title.

13. The display apparatus according to claim 6, wherein the remote control device comprises a counterprogram checking button to conduct display on the second region.
